(19) United States
(12) Patent Application Publication
(10) Pub. No.: US 2006/0201882 A1
(43) Pub. Date: Sep. 14, 2006

(54) Method and system for treating wastewater containing hydrogen peroxide

(75) Inventors: Hsiao-Yu Chen, Hsinchu (TW); Kon-Tsu Kin, Hsinchu (TW); Hong-Shiang Tang, Hsinchu (TW); Wen-Tsang Chen, Hsinchu (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 11/075,858

(22) Filed: Mar. 10, 2005

(51) Int. Cl. C02F 1/44

(52) U.S. Cl. 210/639; 210/669; 210/743; 210/759

(57) ABSTRACT

The present invention provides an improvement for H₂O₂-containing wastewater treatment, wherein activated carbon for reducing the hydrogen peroxide content in the wastewater has an enhanced efficiency and a longer useful lifetime. The method of the present invention monitors a pH value of the H₂O₂-containing wastewater, and adjusts the pH value to 4 or higher by adding a base, when the pH is lower than 4, prior to causing the wastewater to contact activated carbon.

### FIELD OF THE INVENTION

The present invention relates to a method for treating wastewater containing hydrogen peroxide, and particularly to a method for treating wastewater containing hydrogen peroxide with activated carbon.

### BACKGROUND OF THE INVENTION

Hydrogen peroxide is an oxidant commonly used in semiconductor processes. For example, industry names of cleaning solutions for washing wafers include SPM (with a composition of H₂SO₄:H₂O₂ of 1:4), HPM (with a composition of HCl:H₂O₂: DIW (deionized water) of 1:2:5), SC1 (with a composition of NH₄OH: H₂O₂:DIW of 0.25:1:5). Wastewater discharged after receiving treatment with one of these cleaning solutions contains a high concentration of hydrogen peroxide. Furthermore, the quantity of such wastewater is rather large—about ⅓ of the total wastewater discharged in a semiconductor process. At present, most plants directly discharge this type of wastewater to a wastewater treatment plant without recovery. In recent years, however, due to an ever increasing threshold on the water recovery ratio required by law, and a constant increase in the frequency of the occurrences of water shortages, a semiconductor plant needs to recover this type of acidic wastewater containing a high concentration of oxidant in the future in order to comply with the law and meet the plant's demand for water.

In a typical water treatment process, a water recovery system commonly consisted of an activated carbon tower, together with other units, such as a membrane filtration unit, an ion exchange resin tower, etc. The main purpose for installing the activated carbon tower is to remove the suspension solids (SS) and to absorbe total organic contaminants (TOC). The main purpose for installing an ion exchange tower is to eliminate the electrical conductivity in water caused by anions and cations. A membrane filtration unit includes a unit, such as an ultrafiltration (UF) unit, a reverse osmosis (RO) unit, etc., for removing dissolved TOC, SiO₂, F⁻, TDS (total dissolved solids), etc., and obtaining recycled water at a desired quality.

Therefore, though commonly used in the typical water treatment process, activated carbon can also produce a partial removal effect of hydrogen peroxide. However, removing hydrogen peroxide is not a main objective in the use of activated carbon, and activated carbon has a limited effect in removing hydrogen peroxide, and does not effectively remove hydrogen peroxide at high concentrations in water. Thus, in the typical techniques of removing hydrogen peroxide from water, the following conventional methods have been used to reduce the damage to a recovery system caused by hydrogen peroxide:
Using a redox potential measurement to control the redox potential of wastewater to less than 175 mV in order to reduce the oxidation power of an oxidant on the treatment system;
Adding sodium sulfite to reduce the number of H₂O₂ molecules, H₂O₂+Na₂SO₃→H₂O+Na₂SO₄
Increasing the pH value of wastewater to reduce the oxidation power of H₂O₂: Because H₂O₂ is a weak acid, when the pH=11.5, 50% of H₂O₂ will be converted into ionic (H₂O₂)⁻ that is without oxidation power, which reduces the overall oxidation power of H₂O₂;
Using activated carbon to adsorb H₂O₂;
Reducing the content of heavy metals in acidic wastewater: The presence of heavy metals promote the conversion of H₂O₂ into hydroxyl radicals, leading to a large increase of the oxidation power and an increase of damage to the RO membrane, etc.

Research has shown that an ion exchange resin will dissolve within 24 hours when the concentration of hydrogen peroxide reaches 500 ppm or higher. More data indicates that the functions of an ion exchange resin is affected when the concentration of hydrogen peroxide in water exceeds ppm. Therefore, there is a need to remove hydrogen peroxide from wastewater before wastewater can be further recycled.

Prior art in using activated carbon for removing H₂O₂ from water includes, for example, Taiwan Patent No. 197382 (1993), which discloses an activated carbon filter for removing hydrogen peroxide from a fluid. The activated carbon filter includes a gravel bed located on a first end thereof, an activated carbon bed located on a second end thereof, an inlet device, and an outlet device. The inlet device distributes a hydrogen peroxide-containing fluid to contact in succession the gravel bed and the activated carbon bed; subsequently, the fluid flows out of the filter through the outlet device. Japan Patent Laid-Open No. 7-171561 discloses a wastewater treatment method for removing hydrogen peroxide by using a packed tower loaded with a granular activated carbon. Two serially connected front and rear section packed towers loaded with a granular activated carbon are used. The above-mentioned two patents are both related to the hardware design of a packed tower loaded with activated carbon, and do not mention the use of controlling the pH value of wastewater to increase the efficiency and operational lifespan of the activated carbon.

### SUMMARY OF THE INVENTION

A major objective of the present invention is to provide a method and a system for treating wastewater containing hydrogen peroxide by using activated carbon.

Another objective of the present invention is to provide a method and a system for treating acidic wastewater containing hydrogen peroxide by using activated carbon.

In order to accomplish the aforesaid objectives a method for treating wastewater containing hydrogen peroxide provided according to the invention of the present application comprises the following steps: (a) controlling the wastewater containing hydrogen peroxide to a H value of 4 or higher; and (b) contacting the wastewater having a pH value of 4 or higher from step (a) with an activated carbon bed to reduce the content of hydrogen peroxide in the wastewater.

Preferably, the control of the pH value in step (a) enables the activated carbon bed in step (b) to contact wastewater with a pH value of 4 to 7.

Preferably, the control of the pH value in step (a) comprises introducing the wastewater containing hydrogen peroxide into a pH adjustment unit, measuring the pH value of the wastewater in the pH adjustment unit, and adding an alkali or an acid into the wastewater in the pH adjustment unit according to the variation of the pH value with time.

Preferably, the method of the present invention further comprises using a membrane to filter wastewater having a reduced hydrogen peroxide content from the activated carbon bed in step (b) in order to filter out solid particles therein. More preferably, the method of the present invention further comprises contacting the filtered wastewater with an ion exchange resin in order to remove charged ions therein.

Preferably, the method of the present invention further comprises using a reverse osmosis membrane to further purify the filtered wastewater.

Preferably, the wastewater containing hydrogen peroxide has a pH value less than 4, and the pH value control in step (a) comprises adding an alkali into the wastewater containing hydrogen peroxide.

The present invention also dislcoses a system for treating wastewater containing hydrogen peroxide, which comprises:

a pH adjustment unit for controlling the pH value of a wastewater containing hydrogen peroxide to a value of 4 or higher; and

an activated carbon bed for receiving a discharged wastewater with a pH value of 4 or higher from the pH adjustment unit in order to reduce the content of hydrogen peroxide in the wastewater.

Preferably, the pH adjustment unit includes a pH adjustment tank and a chemical addition device control unit, wherein the pH adjustment tank is used to mix the wastewater containing hydrogen peroxide with an alkali or acid, and the chemical addition device control unit is used to measure the pH value of the wastewater in the pH adjustment unit and add an alkali or an acid into the wastewater in the pH adjustment unit according to the variation of the pH value with time.

Preferably, the treatment system of the present invention further comprises a membrane filtration unit, which receives the wastewater having a reduced content of hydrogen peroxide from the activated carbon bed to filter out solid particles therein. More preferably, the treatment system of the present invention further comprises an ion exchange resin adsorption unit, which receives the filtered water from the membrane filtration unit to remove charged ions therein; or further comprises a reverse osmosis unit, which receives the filtered water from the membrane filtration unit to obtain purified water.

The present invention controls the pH value of wastewater to a suitable range for inducing activated carbon to impair the catalytic function of hydrogen peroxide, thereby increasing the treatment efficiency of activated carbon in removing hydrogen peroxide in water. Thus, the removal ratio of hydrogen peroxide by activated carbon is increased, and the activated carbon has a longer operational lifespan in environments having high concentrations of hydrogen peroxide (>400 ppm). In comparison with a method without using activated carbon according the present invention, a method according to the present invention can effectively increase the operational lifespan of activated carbon by more than 10 fold.

### BRIEF DESCRIPTION OF THE DRAWINGS

FIG. 1 is a block diagram of a method for treating wastewater containing hydrogen peroxide according to a preferred embodiment of the present invention.

FIG. 2 is a graph of experimental results of using an activated carbon column in treating wastewater with pH values of 2, 4, 8, and 10.

FIG. 3 is a block diagram of a system for treating wastewater containing hydrogen peroxide according to an embodiment of the present invention.

FIG. 4 is a graph of experimental results of wastewater containing hydrogen peroxide with pH values of 2 and 6 continuously treated by the system of FIG. 3.

### DETAILED DESCRIPTION OF THE INVENTION

The present invention discloses a method for increasing the power of activated carbon in removing hydrogen peroxide from water. Thus, a high concentration of hydrogen peroxide can be removed from acidic wastewater according to a technique of the present invention without damaging downstream membranes, resin units, etc., for the convenience of recovery of the wastewater and conservation of water resources. The technical means in achieving the above objectives mainly adopts a control of the pH value of the wastewater prior to entering an activated carbon treatment unit for controlling the pH value of the wastewater to a desired range (pH≧4) in order to induce the activated carbon to produce a catalytic function in breaking up hydrogen peroxide, thereby prolonging the operational lifespan of the activated carbon.

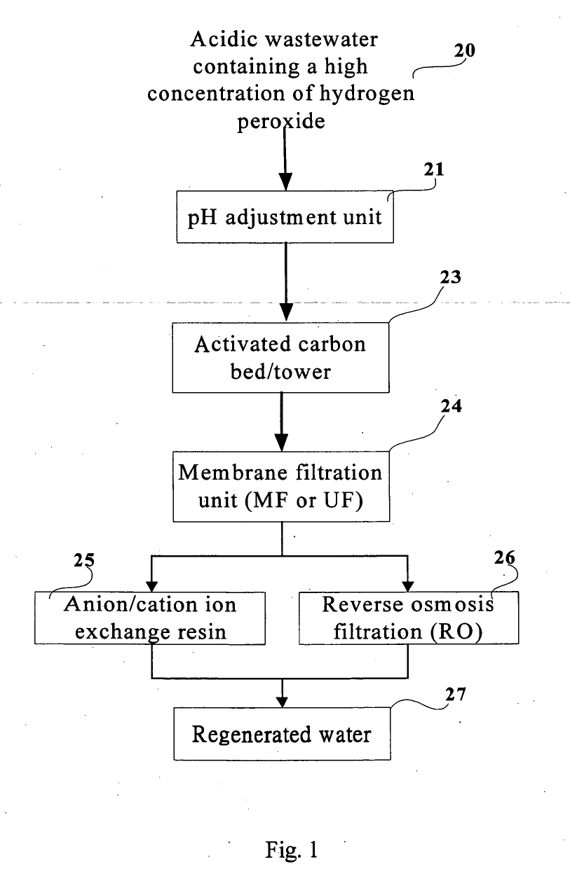

A method for treating wastewater containing hydrogen peroxide according to a preferred embodiment of the present invention is explained in the following with reference to FIG. 1.

Acidic wastewater 20 containing a high concentration of hydrogen peroxide is adjusted to a pH value greater than or equal to 4 by the addition of an alkali solution from a pH adjustment unit 21 prior to entering an activated carbon bed (tower) 23.

The activated carbon in the activated carbon bed (tower) 23 is induced by the adjusted pH value of the wastewater to generate a catalytic function in breaking up hydrogen peroxide. Experimental results indicate that more than 99% of hydrogen peroxide can be removed from wastewater that is adjusted to a pH value larger than 4 and that contains 348 ppm of hydrogen peroxide (as shown in Table 1). Thus, a high concentration of hydrogen peroxide passing through the activated carbon bed (tower) 23 and oxidizing a subsequent treatment unit (membrane 24, ion exchange resin 25, or reverse osmosis membrane 26) is avoided.

After the above-mentioned step of removing high concentrations of hydrogen peroxide, the acidic wastewater enters a membrane filtration unit 24 for the removal of fine particles in the water or fine carbon particles caused by the decomposition of hydrogen peroxide in order to protect a subsequent treatment unit. The membrane filtration unit 24 can be a micro filter (MF) or an ultra filter (UF) membrane.

A large quantity of ions in the acidic wastewater can be removed by an ion exchange resin 25 or a reverse osmosis membrane (RO) 26 or a combination of the two to increase the removal effect of soluble ions or organic contaminants. After undergoing the above-mentioned treatment steps, water can be used as reprocessed water 27 and recycled.

As shown in the process of FIG. 1, the pH adjustment unit 21 performs a pH measurement step, an alkali solution addition step according to the pH value and the quantity of water, and a mixing step of the alkali solution and the acidic wastewater. When a plurality of parallel activated carbon beds (towers) 23 are used, the pH adjustment unit 21 further performs a step of switching the pH-adjusted acidic wastewater into different activated carbon beds (towers) 23. The pH adjustment unit 21 can use a conventional chemical engineering process method (e.g. a PID method) to control the pH value.

A person skilled in the art can alter, modify or omit the membrane filtration unit 24, the ion exchange resin 25 or the reverse osmosis 26, and/or additional auxiliary wastewater treatment units in FIG. 1 to meet the requirements of different wastewater sources.

### EXAMPLE

This example used acidic wastewater from a semiconductor plant to verify the effectiveness of the invention method. The objective of the treatment was to obtain treated water in compliance with a next-generation water quality standard.

The acidic wastewater from a semiconductor plant had a pH value of about 1˜3, and a concentration of hydrogen peroxide of about 100˜400 ppm. In order to determine the treatment power of the activated carbon for designing an activated carbon tower, a batch experiment and a continuous column experiment were conducted to obtain the required parameters, and then a test was conducted on the actual plant system.

(a) Batch Experiment

According to a jar-test design, 500 mL of tap water was prepared to contain 350 ppm H₂O₂, and adjusted to a pH value of 2 by H₂SO₄ to simulate the acidic wastewater of an actual plant. Next, different wastewaters with pH values of 4, 8 and 10 were separately prepared by using NaOH. 50 g of activated carbon was separately added into different cups containing different wastewater with a specific pH value. Next, the wastewater in each cup was agitated at 130 rpm, and the results were recorded in Table 1.

From the experiment, wastewater with a pH value of 2 contained 38.0 ppm H₂O₂ after receiving treatment for 60 minutes, and 9.00 ppm H₂O₂ after receiving treatment for 90 minutes. However, if the wastewater had a pH value of larger than 4, a vigorous reaction between the highly concentrated hydrogen peroxide in the wastewater and the activated carbon was observed, and the hydrogen peroxide decomposed, resulting in the formation of oxygen bubbles, thereby increasing the hydrogen peroxide removal power of the activated carbon—only 2.40 ppm H₂O₂ remained after receiving treatment for 60 minutes, and only 0.14 ppm H₂O₂ remained after receiving treatment for 90 minutes. This experiment also indicated that the activated carbon maintained a substantially equal hydrogen peroxide removal power after a number of repetitive experiments when the pH value of the wastewater was adjusted to 4, 8, or 10.

TABLE 1
Effect of pH variation on removal of hydrogen peroxide

| | pH = 2 | | | pH = 4 | | |
|---|---|---|---|---|---|---|
| Time | | Conductivity | H₂O₂ | | Conductivity | H₂O₂ |
| (min) | pH | (μS/cm) | (ppm) | pH | (μS/cm) | (ppm) |
| 0 | 2.01 | 9600 | 354 | 4.09 | 3660 | 348 |
| 15 | 2.20 | 6460 | 197 | 7.84 | 3620 | 100 |
| 30 | 2.25 | 5850 | 107 | 8.03 | 3630 | 25.6 |
| 60 | 2.36 | 5500 | 38.0 | 8.07 | 3630 | 2.40 |
| 90 | 2.28 | 5350 | 9.00 | 8.11 | 3660 | 0.14 |
| | pH = 8 | | | pH = 10 | | |
| Time | | Conductivity | H₂O₂ | | Conductivity | H₂O₂ |
| (min) | pH | (μS/cm) | (ppm) | pH | (μS/cm) | (ppm) |
| 0 | 8.04 | 3740 | 342 | 10.01 | 4120 | 336 |
| 15 | 8.33 | 3700 | 98.8 | 8.98 | 4010 | 80.0 |
| 30 | 8.34 | 3730 | 30.2 | 8.86 | 4010 | 18.0 |
| 60 | 8.32 | 3740 | 3.40 | 8.80 | 4040 | 1.20 |
| 90 | 8.42 | 3750 | 0.22 | 8.90 | 4040 | 0.06 |

(b) Continuous Column Experiment

In an actual plant application, the treatment performance of activated carbon was influenced by the properties and retention time of the wastewater, etc., thereby altering the retention time of hydrogen peroxide in the activated carbon tower. Thus, a continuous column experiment was used to investigate the continuous treatment performance of an activated carbon tower.

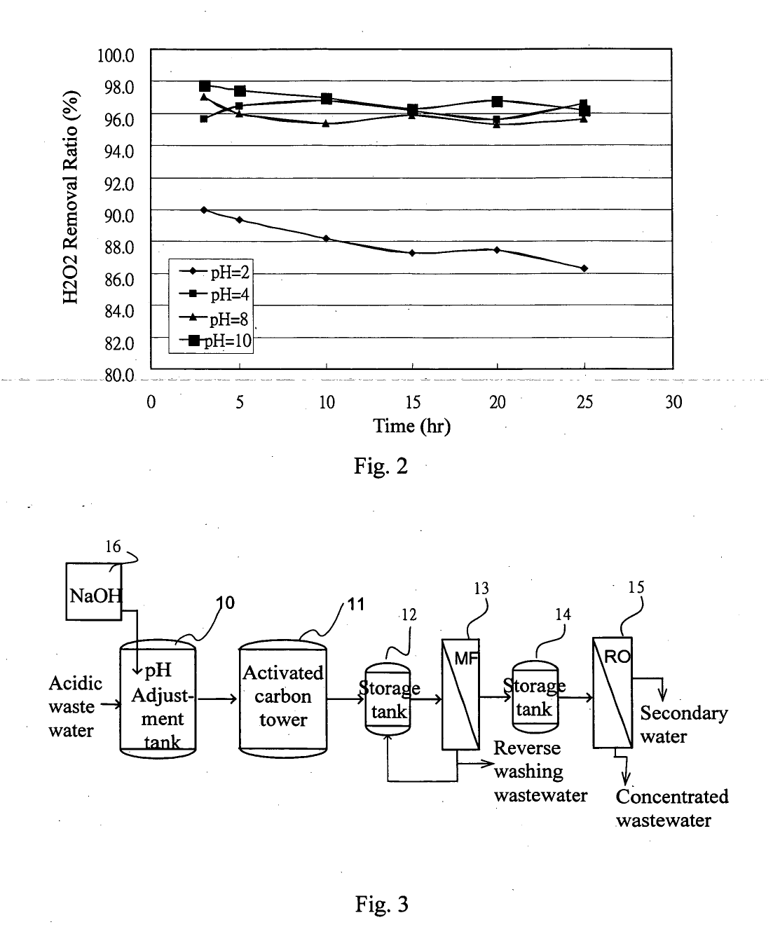

A small column (with an internal diameter of 6.8 cm, and a height of about 20 cm) was used in the experiment. The column was packed with about 430 g of activated carbon for performing a continuous fluid test. Wastewater was prepared by using tap water containing 200 ppm of hydrogen peroxide, and was adjusted to a pH value of 2 by H₂SO₄ to simulate the acidic wastewater from an actual plant. Next, NaOH was used to prepared different wastewaters with pH values of 4, 8, and 10. The wastewater flowed through the activated carbon column at a flowrate of 150 mL/min; after a continuous fluid test of 25 hours, the results are shown in FIG. 2. Experimental results indicated that hydrogen peroxide could be effectively removed from water when the experiment was conducted in conditions where the pH value of the water exceeded or equaled 4, with a hydrogen peroxide removal ratio exceeding 95%.

(c) Test on an Actual Plant System

A process design shown in FIG. 1 was used to design a wastewater treatment system used by this example, as shown in FIG. 3, wherein the design parameters of the activated carbon tower were obtained from the laboratory column test data.

The wastewater from the actual plant had a pH value of about 1˜3, a H₂O₂ concentration of about 200 ppm (sometimes exceeding 400 ppm), and a conductivity of 5,000˜8,000 S/cm.

The process for treating the wastewater from an actual plant comprised: introducing the acidic wastewater into a pH adjustment tank 10, using a pH meter to measure the pH value of the acidic wastewater, using a chemical addition control unit 16 to control the addition of NaOH in order to control the pH value of the acidic wastewater to be ≧4 (weakly acidic˜neutral), then introducing the wastewater into an activated carbon tower 11. After receiving treatment from the activated carbon tower 11, the wastewater was introduced into a temporary storage tank 12, and from the temporary storage tank 12 was then introduced into a micro-filtration system (MF) 13 for the removal of the fine carbon particles produced during the hydrogen peroxide decomposition process. After receiving treatment from the micro-filtration system (MF) 13, the wastewater was introduced into another temporary storage tank 14. After reaching a sufficient water level, the wastewater was introduced to a reverse osmosis unit 15 for receiving further purification in order to remove soluble ions and organic contaminants. After receiving treatment from the reverse osmosis unit 15 (RO), the purified water was used as next level water and recycled. The concentrated wastewater produced by the reverse osmosis unit 15 and the backwash waste solution produced by the micro-filtration system 13 were all introduced downstream to a conventional treatment unit for further treatment, or discharged directly.

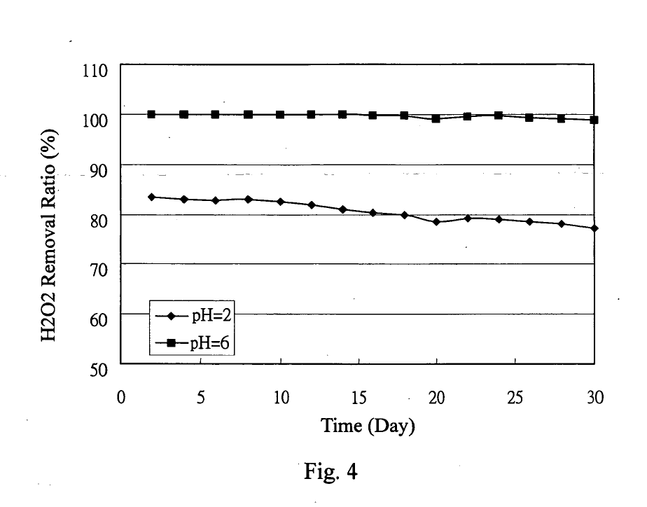

For the above-mentioned wastewater treatment process of an actual plant, the test results of removal of hydrogen peroxide by the activated carbon 11 are shown in FIG. 4. The acidic wastewater was adjusted to a pH value of about 6, and the hydrogen peroxide removal ratio was greater than 99% over long term monitoring. In another control experiment, the raw water was not adjusted for its pH value and was directly introduced into the activated carbon tower. The initial measurements indicated that the H₂O₂ removal ratio was about 83% (within 10 days). However, after continuous operation for 30 days, the removal ratio dropped to 77%, and the concentration of hydrogen peroxide after passing through the activated carbon tower was more than 40 ppm, thereby causing oxidation losses on a subsequent treatment unit (RO). Thus, this experiment indicated that if the acidic wastewater was not adjusted for its pH value (thus having a pH value in the range of 1˜3) and a continuous test was carried out, the H₂O₂ removal efficiency of the activated carbon decreased gradually with the progress of the operation. However, if the pH value of the wastewater was adjusted to about 6, the operational lifespan and the H₂O₂ removal efficiency of the activated carbon were significantly increased.

1. A method for treating wastewater containing hydrogen peroxide, which comprises the following steps: (a) controlling the wastewater containing hydrogen peroxide to a pH value of 4 or higher; and (b) contacting the wastewater having a pH value of 4 or higher from step (a) with an activated carbon bed to reduce the content of hydrogen peroxide in the wastewater.

2. The method as claimed in claim 1, wherein the control of the pH value in step (a) enables the activated carbon bed in step (b) to contact wastewater with a pH value of 4 to 7.

3. The method as claimed in claim 1, wherein the control of the pH value in step (a) comprises introducing the wastewater containing hydrogen peroxide into a pH adjustment unit, measuring the pH value of the wastewater in the pH adjustment unit, and adding an alkali or an acid into the wastewater in the pH adjustment unit according to the variation of the pH value with time.

4. The method as claimed in claim 1 further comprising using a membrane to filter wastewater having a reduced hydrogen peroxide content from the activated carbon bed in step (b) in order to filter out solid particles therein.

5. The method as claimed in claim 4 further comprising contacting the filtered wastewater with an ion exchange resin in order to remove charged ions therein.

6. The method as claimed in claim 4 further comprising using a reverse osmosis membrane to further purify the filtered wastewater.

7. The method as claimed in claim 1, wherein the wastewater containing hydrogen peroxide has a pH value less than 4, and the pH value control in step (a) comprises adding an alkali into the wastewater containing hydrogen peroxide.

8. A system for treating wastewater containing hydrogen peroxide, which comprises:
a pH adjustment unit for controlling the pH value of a wastewater containing hydrogen peroxide to a value of 4 or higher; and
an activated carbon bed for receiving a discharged wastewater with a pH value of 4 or higher from the pH adjustment unit in order to reduce the content of hydrogen peroxide in the wastewater.

9. The treatment system as claimed in claim 8, wherein the pH adjustment unit includes a pH adjustment tank and a chemical addition device control unit, wherein the pH adjustment tank is used to mix the wastewater containing hydrogen peroxide with an alkali or acid, and the chemical addition device control unit is used to measure the pH value of the wastewater in the pH adjustment unit and add an alkali or an acid into the wastewater in the pH adjustment unit according to the variation of the pH value with time.

10. The treatment system as claimed in claim 8 further comprising a membrane filtration unit, which receives the wastewater having a reduced content of hydrogen peroxide from the activated carbon bed to filter out solid particles therein.

11. The treatment system as claimed in claim 10 further comprising an ion exchange resin adsorption unit, which receives the filtered water from the membrane filtration unit to remove charged ions therein.

12. The treatment system as claimed in claim 10 further comprising a reverse osmosis unit, which receives the filtered water from the membrane filtration unit to obtain purified water.
